(19) United States
(12) Patent Application Publication
(10) Pub. No.: US 2025/0170579 A1
(43) Pub. Date: May 29, 2025

(54) DEVICE AND METHOD FOR GRINDING

(71) Applicant: HS-TUMBLER GMBH, Quakenbrück (DE)

(72) Inventor: Bernhard HUKELMANN, Quakenbrück (DE)

(21) Appl. No.: 18/840,965

(22) PCT Filed: Feb. 24, 2023
(86) PCT No.: PCT/EP2023/054747

§ 371 Date: Dec. 5, 2024

(30) Foreign Application Priority Data
Feb. 25, 2022 (DE) 10 2022 201 994.6

(51) Int. Cl. B02C 17/24; B02C 17/04; B02C 17/10

(52) U.S. Cl. CPC B02C 17/24; B02C 17/04; B02C 17/10

(57) ABSTRACT

Device for comminuting solids, comprising a container which is driven to reciprocate along a trajectory curve which can be generated by superimposing the movement along at least two axes, which are at an angle to each other, at different frequencies and/or different speeds along each of the axes, with at least one grinding body loosely contained in the container.

The present invention relates to a device and a method for comminuting, also referred to as grinding, of solids which can be carried out using the device. Preferably, the device is connected to a feed line for solids to be comminuted and to an outlet in order to carry out the method continuously.

The device has the advantage of comminuting solids that have different sizes or a wide size distribution. In an embodiment, the device has the advantage that for elements that move relative to each other and it has no bearings which come into contact with solids or ground material.

U.S. Pat. No. 2,433,872 A describes a ball mill with an annular interior that is tilted about an inclined vertical axis but is not intended to rotate.

U.S. Pat. No. 2,982,485 A describes a ball mill with a cylindrical container whose longitudinal axis is arranged vertically and which is moved on a circular path in a horizontal plane by means of an eccentric drive.

The object of the invention is to provide an alternative device and a method that can be carried out with it, which are set up in particular to adjust the intensity of the grinding.

The invention achieves the object by the features of the claims and in particular by means of a device which, for receiving solids to be comminuted, has a container which is driven along a trajectory curve which can be generated by superimposing the movement along at least two axes, which lie at an angle to one another, to form a reciprocating movement at different frequencies and/or different speeds along each of the axes, with at least one, optionally exactly one, grinding body loosely contained in the container. The container is driven for reciprocating movement along at least one trajectory curve which can be generated by superimposing the reciprocating movement along at least two axes which are at an angle to one another, preferably two of the axes lying in the plane of the cross-section of the container, the reciprocating movement along each axis taking place at different frequencies and/or with a phase offset. The trajectory curve can be generated by superimposing the reciprocating movement along two or three axes at different frequencies and/or with phase offset and has a sequence of trajectory segments, at least one of which, preferably each, comprises or consists of exactly one complete reciprocating movement along the axis along which the reciprocating movement takes place at the lower frequency, the superimposed reciprocating movements at the higher frequency or at the same frequency, in each case optionally with phase offset, along the other axis or axes being comprised therein.

Therein, the lower frequency of the complete reciprocating movement forms the frequency of the sequence of trajectory segments. For each trajectory segment, a frequency ratio of the reciprocating movement along two axes of at maximum 1:20 or of at maximum 1:15 or of at maximum 1:10, maximum 1:4 or of at maximum 1:3 is preferred, more preferably between 1:1 and 1:2, even more preferably greater than 1:1 to 1:2 or up to 1:1.5, e.g. with a frequency ratio of 1:1.001 to 1:2 or up to 1:1.5. In the case of a trajectory curve that can be generated by superimposing the reciprocating movement along two axes at different frequencies and/or with a phase offset, the axes preferably lie in the plane of the cross-section of the container. In the case of a trajectory curve that is formed by superimposing the reciprocating movement along three axes, two of the axes preferably lie in the cross-sectional plane of the container and the third axis is at an angle to this cross-sectional plane. Therein, the lowest frequency of the complete reciprocating movement along one of the three axes forms the frequency of the sequence of trajectory segments.

In general, the linear axes of movement are preferably at right angles to each other. The at least one loose grinding body contained in the container can also be a rolling body, which rolls along the wall of the container during the reciprocating movement along the at least one trajectory curve.

In general, the device is set up to drive the container along a trajectory curve which is formed by superimposing the reciprocating movement of at least two superimposed linear axes which are at an angle to one another, the reciprocating movement along the linear axes taking place at different frequencies and/or with a phase offset. The linear axes, along which the superimposed reciprocating movements take place at different frequencies and/or with phase offset, form the trajectory curve along which the reciprocating movement of the container takes place, for which the device is set up.

By moving the container along the trajectory curve, the device is set up to accelerate the grinding body and solids to be comminuted relative to the container, so that solids contained in the container are comminuted by the acceleration against the container wall and by the movement of the grinding body along or against the container wall.

Since the trajectory curve can be adjusted or predetermined by the different frequencies and/or the phase offset of the superimposed movements along the linear axes, the device is set up for reciprocating movement of the container along the trajectory curve and for relative movement of the grinding body with respect to the container.

The trajectory curve, which can be adjusted or predetermined by the different frequencies and/or the phase offset of the superimposed movements along at least two linear axes, accelerates the at least one grinding body, which can move freely in the container, relative to the container. The reciprocating movement of the container drives the grinding body to move against the inner wall of the container.

Generally preferably, the container is not rotationally driven and further preferably not or not completely rotatable, e.g. rotatable by a maximum of 30° or by a maximum of 20° or 10° about its central axis. Generally preferred, the container is driven exclusively for a reciprocating movement along a trajectory curve.

The trajectory curve can be used to determine the angle of impact and angle of emergence of the grinding body on the container wall. In addition, the device is optionally set up to move the container along the trajectory curve with adjustable or predetermined acceleration and speed. Because the device is set up for an adjustable or predetermined trajectory curve and/or an adjustable or predetermined acceleration and/or an adjustable or predetermined speed along the trajectory curve of the reciprocating movement of the container, the grinding body is driven with adjustable or predetermined acceleration and/or speed relative to the container and permits a predetermined or continuous adaptation of the method to the solid material to be comminuted.

In general, a trajectory curve can be formed by at least two superimposed individual oscillations; preferably, a trajectory curve is equivalent to the trajectory curve that can be generated by superimposing reciprocating movements along at least two linear axes of movement each at different frequencies and/or by phase offset. A reciprocating movement along a trajectory curve that is equivalent to the reciprocating movement along linear axes of movement that are superimposed on each other have different frequencies and/or a phase offset to each other. In general, a trajectory curve is therefore not a circular path.

The difference in frequencies can, for example, be at least 0.01 Hz and/or 0.01% to 900%. The phase offset of the reciprocating movements along the linear axes can be e.g. from 0.01° to 180°, preferably 1 to 179° of 360°, which corresponds to a complete reciprocating movement. Herein, 0.01 to 180° of a complete reciprocating movement of 360° is equal to 0.0028% to 50% of a complete reciprocating movement, 1 to 179° of 360° is equal to 0.28% to 49.7% of a complete reciprocating movement.

Therein, the linear axes of movement are perpendicular or at a different angle, for example, e.g. 5° to 85° to each other, in particular in the plane of the cross-section of the container and/or perpendicular to a central axis of the container. Optionally, the trajectory curve contains at least one straight-line section, the end of which is, for example, an apex of the trajectory curve, at which the at least one grinding body and the solid material to be comminuted are accelerated away from the container wall or against the container wall.

For setting up different frequencies and/or a phase offset of the superimposed reciprocating movements along at least two linear movement axes, these reciprocating movements can be coupled together by a transmission or a link guide and driven by a motor. A transmission driven by a motor, which adjusts the reciprocating movement along the trajectory curve, can have a fixed transmission ratio between the superimposed movements along each axis, or an adjustable transmission ratio, e.g. a continuously or incrementally shiftable gearbox. Optionally, the transmission can be slip-loaded, e.g. have a belt drive or be a friction transmission.

The output speed of the transmission, which drives the reciprocating movement of the container, is preferably at least 1 Hz, more preferably at least 5 Hz, e.g. up to 50 Hz, up to 40 Hz, up to 30 Hz, up to 20 Hz or up to 10 Hz. The output speed of the transmission is equal to the frequency of the reciprocating movement.

Alternatively, the reciprocating movement along each of the linear axes of movement may be driven by a separate motor, wherein for the purposes of the invention the lower output speed is the frequency of the reciprocating movement and forms the frequency of the sequence of trajectory segments. In any embodiment, the speed of each drive motor may be controlled, fixed or variable over the duration of the method.

Therein, the device allows the trajectory curve to accelerate the at least one grinding body in a defined direction to a specific location on the inner wall of the container. The geometry of the container in conjunction with the trajectory curve can support the grinding method so that the trajectory curve can be adjusted depending on the shape and size of the container cross-section.

Optionally, the device is set up to change the trajectory curve of the reciprocating movement and/or the acceleration and/or speed of the reciprocating movement during the method, for example in a first phase to set the reciprocating movement along a first trajectory curve and with a first acceleration and speed and to set the reciprocating movement in a subsequent second phase along a changed trajectory curve and/or changed acceleration and/or speed.

Further optionally, the reciprocating movement is a linear reciprocating movement in a first phase and a reciprocating movement along merging trajectory curves in a second phase. Therein, the trajectory curve can, for example, be determined by a transmission that drives the movement of the container.

By adjusting the trajectory curve and the acceleration of the reciprocating movement of the container, the device allows a predetermined or dynamically variable and directed acceleration of the grinding body relative to the container. Solids that are present between the container wall and the grinding body are loaded and comminuted between the grinding body and the container wall or, in the case of several grinding bodies, between these.

In an embodiment, in which the container can be driven in a controlled manner in a first phase for a linear reciprocating movement, the device is set up to move particles and grinding bodies in perpendicular against the container wall with a controllable acceleration maximum which is significantly greater than the acceleration due to gravity and is therefore essentially independent of the acceleration due to gravity, e.g. with an acceleration maximum of at least 15 m/s², preferably 25 m/s², preferably at least 50 m/s² or at least 100 m/s² or at least 200 m/s² or at least 350 m/s², e.g. up to 500 m/s² in each case.

In general, the device can be set up to accelerate the container with an acceleration maximum of at least 20 m/s² or at least 200 m/s², e.g. at least 300 m/s², preferably up to 1000 m/s² along the trajectory curve, e.g. at an apex of the trajectory curve.

The container is preferably driven for move reciprocating movement with an acceleration maximum of at least 0.5 m/s² or at least 1 m/s² or at least 2 m/s², at least 3.5 m/s², preferably at least 60 m/s², more preferably at least 100 m/s², at least 150 m/s², at least 160 m/s², at least 200 m/s², e.g. up to 300 m/s² or 450 m/s², up to 260 m/s² or up to 250 m/s² along each of two axes. Generally preferably, in combination with the acceleration maximum the container is driven to an average speed of at least 0.5 m/s, preferably at least 2 m/s, more preferably at least 3.5 m/s, e.g. up to 10 m/s or up to 20 m/s or up to 6 m/s, e.g. 3 to 4 m/s, in each case along one of the axes, preferably along each axis. Therein, the path of the movement along at least one axis, preferably along each axis, is e.g. 0.1 cm to 24 cm.

The container can, for example, be driven to reciprocating movement along each axis extending over a distance of at least 1 mm or at least 2.5 mm, at least 1 cm, more preferably at least 2 cm or at least 5 cm, at least 10 cm or at least 15 cm, e.g. up to 100 cm, up to 50 cm, up to 30 cm or up to 20 cm in each case. Further preferably, the reciprocating movement of the container is harmonious. The reciprocating movement of the container can be linear in a first phase, generally the trajectory curve is non-linear and can, for example, be sinusoidal, triangular or arcuate, optionally running along a so-called Lissajous figure or hypocycloid, which preferably lies in the plane, or is two-dimensional, optionally three-dimensional. Preferably, the reciprocating movement is linear in a first phase and in a second phase along at least two merging, non-linear trajectory segments, each containing at least one apex, to form a trajectory curve. In general, a non-linear trajectory curve, e.g. a movement along a trajectory curve whose trajectory segments each have at least one apex, promotes a collision between the grinding body and the solids to be ground, e.g. in perpendicular to the container wall, as well as at least in sections a uniform and intensive rolling of the grinding body along the container wall, wherein the grinding body and the solids to be ground are moved along the container wall.

Preferably, the reciprocating movement comprises the reciprocating movement along a trajectory curve which comprises at least two, preferably at least three, more preferably at least four trajectory segments, each of which has at least one apex. Each of the movement axes, along which the movements are superimposed to form a trajectory curve, can generally be linear or arcuate, so that the non-linear movement of the container along a sequence of path segments results from the superimposition of the movements along two axes of movement the apices and intermediate sections of a trajectory segment are determined by the frequency difference and/or the phase position of the superimposed reciprocating movements along at least two axes. In general, the device can be set up to change the frequency difference and/or the phase position during the reciprocating movement.

Generally preferred, the container wall is the circumferentially closed wall of the container, which extends around a central axis and between respective terminal opposite cross-sections or lids attached thereto. The container has an optionally circular cross-section that extends around a central axis and is spanned by the container wall. Generally preferably, the terminal cross-sectional surfaces of the container are each covered by a lid, at least one of which optionally has a through opening.

It is generally preferred that at least one trajectory segment has an apex in which the direction of the trajectory segment changes by at least 90°, more preferably by at least 120°, even more preferably by at least 180° or at least 210°, e.g. within a maximum of 24.5%, a maximum of 24%, a maximum of 23%, a maximum of 22%, a maximum of 21%, a maximum of 20%, a maximum of 15% or a maximum of 10%, more preferably a maximum of 5% or a maximum of 3%, a maximum of 2% or a maximum of 1% of the length of a trajectory segment. This is because an apex of the trajectory segment leads to a strong relative acceleration of the grinding body against the container.

The container contains at least one, optionally exactly one grinding body, or at least two grinding bodies. The at least one grinding body is arranged to be freely movable in the container.

The device and the method can be used for vibratory finishing.

The grinding body can have a cross-section which, when the grinding body is arranged with its cross-section parallel to the cross-section of the container, is circular, oval or at least triangular, square, pentagonal, hexagonal, preferably at least 8-sided or at least 12-sided, optionally with grooves and/or protruding webs arranged perpendicular to the cross-section of the grinding body in order to allow the grinding body to roll along the container wall during movement along the two axes of movement.

Optionally, the container can have an inner cross-section which corresponds to the cross-section of the at least one grinding body and which surrounds the grinding body at a spacing. Therein, the grinding body, in particular driven by the movement of the container along a trajectory curve, can be moved against opposing surfaces of the container and parallel to the surfaces of the container. For example, the grinding body may have a triangular cross-section and the container may have an at least triangular inner cross-section, or the grinding body may have a square cross-section and the container may have an at least square inner cross-section, or the grinding body may have a pentagonal cross-section and the container may have an at least pentagonal inner cross-section, or the grinding body may have a hexagonal cross-section and the container may have an at least hexagonal inner cross-section. Generally, preferably in the case of a container having an at least triangular cross-section or a polygonal cross-section, the movement can take place along a sequence of trajectory segments each having at least one apex, preferably each trajectory segment having a number of apices equal to the number of corners of the cross-section of the container. Alternatively or additionally, the number of apices of each trajectory segment may be equal to the number of corners of the cross-section of the container. The apices may, for example, include an angle that is at least twice as large, preferably at least three times as large, as the angle included by one of the adjacent trajectory curves.

Optionally, the grinding body can have a cross-section that is continuously offset along its central axis, so that the cross-section is twisted, for example, in a spiral-shape around the central axis. Therein, it is preferred that the inner cross-section of the container at a spacing from the grinding body has the same cross-sectional shape, which is continuously offset along the central axis of the container, so that the inner cross-section is twisted, for example, in a spiral around the central axis. In this embodiment, the movement of the grinding body in the container can generate a conveying effect in the direction of the central axis of the container and of the grinding body and/or press the grinding body against a lid which covers a cross-sectional opening of the container.

In particular, a grinding body which has a cross-section with at least three corners, which is arranged in a container with an inner cross-section which corresponds to the cross-section of the at least one grinding body, and which encloses the grinding body at a spacing the grinding body may be hollow and have at least one through opening connecting its inner cavity to its outer surface. A grinding body having a through opening to its inner cavity allows fine particles to enter this cavity and, optionally, particles to be discharged from the cavity of the grinding body, for example by means of an opening in a lid covering the cross-section of the container, wherein further preferably the grinding body having a cross-section which is continuously offset along its central axis. The opening in the lid is preferably located centrally therein, so that it is covered by the inner cavity of the grinding body when the grinding body moves along the lid in contact with the lid.

Generally, preferably in the case of a container having an at least triangular cross-section or a polygonal cross-section, the movement can take place along a sequence of trajectory segments each having at least one apex, preferably each trajectory segment having a number of apices equal to the number of corners of the cross-section of the container. Alternatively or additionally, the number of trajectory segments can be equal to the number of corners of the cross-section of the container and/or equal to the number of apices of each trajectory segment. The apices may, for example, comprise an angle which is at least twice as large, preferably at least three times as large, as the angle encompassed by one of the adjacent trajectory curves.

The grinding body can also serve as vibratory grinding body, e.g. nutshells, and the method can be used for vibratory grinding.

Alternatively, the grinding body can have a cross-section which has a wide surface which is wider by a factor of at least 1.5, preferably of at least 2, more preferably of at least 2.5 or of at least 3, than the thickness of the grinding body perpendicular to the wide surface. Therein, the grinding body is arranged, for example, with its wide surface adjacent to the container wall, so that its thickness perpendicular to the wide surface extends from the container wall into the clear cross-section of the container, e.g. along its radial. Such a grinding body has a cross-section that leads to sliding along the container wall when the container moves along the two axes of movement. The side surfaces of the grinding body adjacent to the wide surface can have a square, triangular or oval cross-section that extends perpendicular to the longitudinal longitudinal extension. The wide surface and the side surfaces of the grinding body can extend along its longitudinal extension. For the purposes of the invention, a body of this shape, which slides along the container wall and forms a friction body, is also referred to as a grinding body.

The side surface can be convex, e.g. with a radius equal to or smaller than the radius of the container wall. Alternatively, the wide surface can be flat. Generally preferably, the wide surface has a chamfer along at least one longitudinal edge, more preferably along both longitudinal edges, in which a side surface is adjacent. A chamfer along at least one or both of the longitudinal edges of the wide surface of the grinding body has the effect of making it easier for particles to get between the container wall and the grinding body sliding along it.

It is generally preferred that the cross-section of the grinding body is constant in shape and dimensions along its longitudinal extension.

Generally preferably, the grinding body has a longitudinal extension perpendicular to its cross-section which is greater than the diameter of its cross-section by a factor of at least 1.2, preferably at least 1.5, more preferably at least 2. Therein, the grinding body can have a longitudinal extension which comprises at least 80%, preferably at least 90% or at least 95% of the height of the container, perpendicular to the cross-section of the container.

Preferably, the grinding body has a lower density than the solids to be ground, or the grinding body is selected to have a lower density than the solids to be ground. Preferably, the device is therein and generally set up to drive the container with a high acceleration maximum for reciprocating movement, e.g. to an acceleration maximum of at least 50 m/s², more preferably at least 100 m/s² or at least 200 m/s², e.g. up to 1000 m/s². This embodiment is preferred for a method for comminuting solids contained in a liquid.

In an embodiment, the container wall can be cylindrical, preferably in combination with a grinding body which has a constant cross-section over its longitudinal extension. In a further embodiment, the container wall can be curved along the central axis of the container or between its terminal cross-sections, wherein the container wall preferably spans an interior which is concave to the center axis of the container and/or symmetrical along the central axis of the container.

Optionally, the wall of the container, which extends along its central axis and spans the opposing terminal cross-sectional openings, has openings and this wall is encompassed at a spacing by an outer wall. In this embodiment, the container has a double wall, the inner wall of which has openings for the passage of particles and serves as a sieve, while the outer wall surrounding it collects particles. The openings can be cylindrical or conical, further optionally the openings can be arranged radially to the central axis of the wall or extend at an angle of e.g. 10 to 45° to radials emanating from the longitudinal axis of the cross-section spanned by the wall, or to radials of the central axis. The openings can be round holes or elongated holes that extend parallel or perpendicular to the cross-section of the interior volume, or that extend at an angle>0° to <90° to the cross-section of the interior volume. Optionally, the through-holes have a constant cross-section or a cross-section that widens with increasing distance from the longitudinal axis. Optionally, the through-holes have a chamfer, preferably curved, in order to avoid sharp edges adjacent to the cross-section. Alternatively, the through-holes do not have a chamfer and adjoin the inner wall at an edge, e.g. at 90° or with an undercut in the case of widening through-holes. In a simple embodiment, the inner wall can be a grid, the webs of which form the through-holes between them. Preferably, the gap formed by the spacing of the outer wall from the inner wall is provided at one or both end open cross-sections or at the outer wall with a connected line, which can be pressurized with negative or positive pressure, for example.

The container for the reciprocating movement along two or three axes of movement can have a drive, which is set up by means of a control system to execute the reciprocating movement essentially or exclusively only linearly in a first phase, e.g. along exactly one of the axes of movement, and in a subsequent second phase, which preferably immediately follows the first phase, to execute the reciprocating movement along trajectory segments which merge into one another and which are optionally Lissajous curves or hypocycloids. In the first phase, the particles to be committed and the at least one grinding body are linearly accelerated and allowed to impact against a section of the container wall in order to achieve coarse comminution, which can also be referred to as an impact effect on the particles. In the second phase, particles and the at least one grinding body are moved along the container wall to achieve a finer comminution. Depending on the shape of the grinding body and the amount of the acceleration maximum and amplitude of the reciprocating movement, particles are subjected to a frictional and/or pressing effect in the second phase. When controlling the reciprocating movement of the container along merging trajectory curves and/or in at least a first phase and a subsequent second phase, the at least one grinding body can have a spherical shape. The first phase of the reciprocating movement can, for example, account for 10 to 50%, preferably up to 30 or up to 20% of the total duration of the reciprocating movements, and the second phase can account for the remaining portion up to 100%.

The control of the drive of the container is optionally controlled depending on the signal of a sensor, preferably an acoustic sensor, which picks up vibrations, in particular noises of the container during the reciprocating movement, in particular during the first and/or during the second phase. The acoustic sensor can, for example, be attached to the outer surface of the container or fixed at a spacing from the container in a position past which the reciprocating movement of the container passes. Preferably, the acoustic sensor is fixed at a small spacing, e.g. from 0.5 to 5 cm, from the apex of the reciprocating movement, e.g. fixed to a frame relative to which the container is moved along the trajectory curve. The acoustic sensor can be a vibration sensor, e.g. a microphone. In this embodiment, the control of the reciprocating movement can be set up, when the signal emitted by the acoustic sensor changes by a predetermined deviation within a predetermined time of the reciprocating movement, and/or when a predetermined signal emitted by the acoustic sensor is reached, to allow the reciprocating movement to run at a changed speed and/or with a changed phase offset and/or to control it from a linear movement into a trajectory curve, in particular to control it from a first phase to a second phase of the reciprocating movement.

The sensor can also be an optical sensor attached to the container, e.g. a turbidity sensor.

Optionally, a device for generating electrical voltage is attached to the container, in particular a device with a magnet and a coil arranged to move relative to the magnet, which are set up to generate electrical voltage at relative movement to each other. This device is preferably connected to a transmitter attached to the container by means of an electrical cable in order to apply electrical voltage to the transmitter. The transmitter is preferably connected to at least one of the sensors by means of a data line in order to receive sensor signals. Therein, the transmitter is set up, for example, to transmit received sensor signals. Furthermore, the sensor can be connected to the device for generating electrical voltage by means of an electrical line. In this embodiment, the device is set up so that a sensor attached to the container and a transmitter can be energized by the device for generating electrical voltage as soon as the container is moved along the trajectory curve. Accordingly, the device may be formed without an electrical cable extending between a frame relative to which the container is moved and the container.

The method can be used, for example, to produce powdered chemicals, e.g. carbon black or mineral color pigments, even from coarse minerals, or to produce powdered sugar.

The particles to be comminuted can be contained with a liquid phase in an emulsion or suspension, e.g. in the production of fine emulsions or conching in chocolate production using the method.

The device can be integrated in a pipe line or hose line, respectively, which is connected to an inlet opening and an outlet opening of the container in a fixed or reversibly detachable manner in order to carry out the method continuously or in batches.

The invention will now be described in more detail with reference to figures which schematically show in

FIG. 1 a cylindrical embodiment of the container,

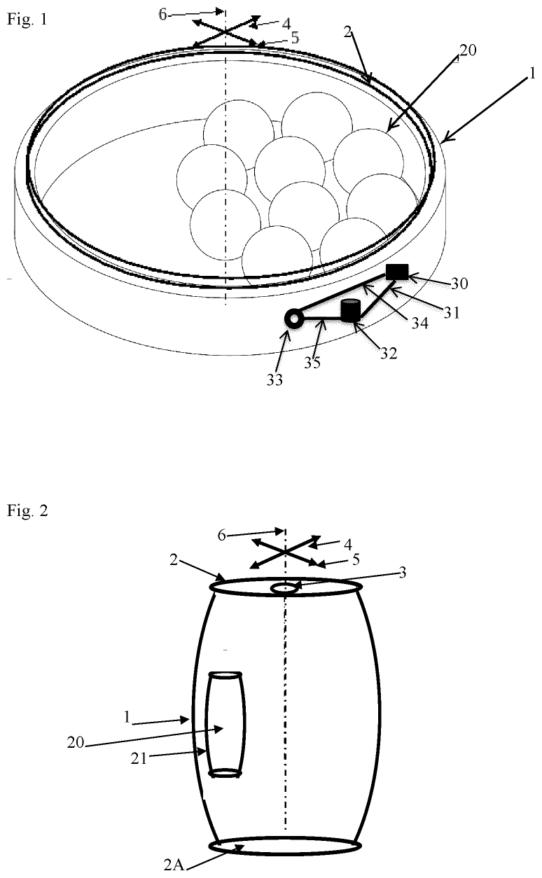

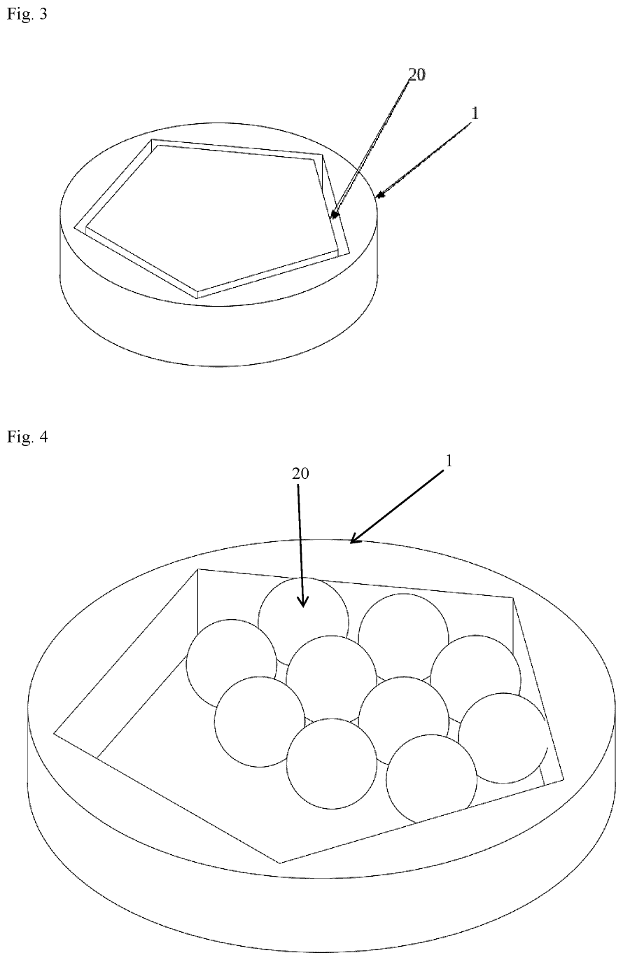

FIG. 2 an embodiment of the container with a concave interior,

FIG. 3 an embodiment of the container with a pentagonal inner cross-section and with a grinding body of the same cross-sectional shape contained therein at a spacing,

FIG. 4 an embodiment of the container with a pentagonal inner cross-section and spherical grinding body contained therein,

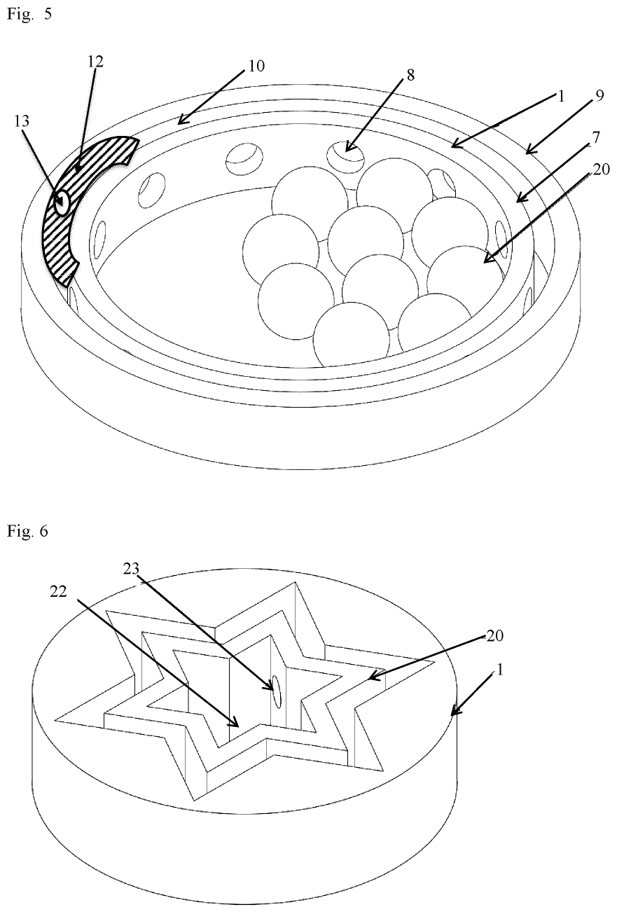

FIG. 5 an embodiment of the container with a double wall,

FIG. 6 an embodiment of the container with a hexagonal inner cross-section and with a grinding body which is hollow of the same cross-sectional shape contained therein at a spacing, and in

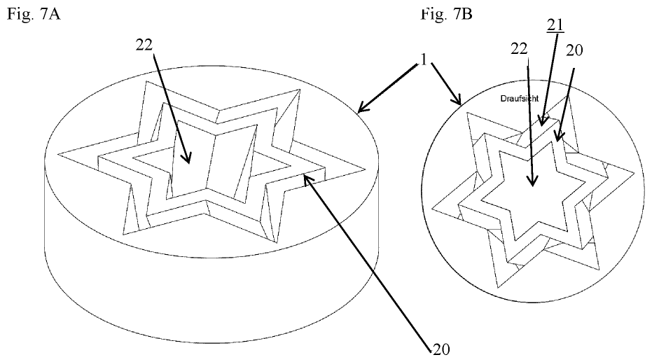

FIG. 7A in perspective view and in FIG. 7B in top view of the cross-section of a container an embodiment of the container with an angular inner cross-section, which is continuously offset along its central axis, and a grinding body of the same cross-sectional shape contained therein at a spacing.

FIG. 1 shows a cylindrical container 1 in which several freely movable balls are contained as grinding body 20. The terminal cross-sections of the container 1 are each covered with a lid 2, 2A, at least one of which can have a through-opening 3, e.g. for feeding particles to be comminuted and/or removing ground particles.

The axes 4, 5, along which the movements of the container 1 are superimposed to form a sequence of trajectory segments that form a trajectory curve and along which the container 1 is driven to move reciprocating, are preferably arranged perpendicular to the longitudinal central axis 6 of the container 1.

A sensor 30, which is attached to the container 1, is connected by means of an electrical line 31 to a device 32 attached to the container 1 for generating electrical voltage, which has a magnet that can move relative to a coil. A transmitter 33 is connected to the sensor 30 by means of a data line 34 and to the device 32 for generating electrical voltage by means of an electrical line 35.

FIG. 2 shows a container 1, the interior of which is concave in relation to its longitudinal central axis 6. The grinding body 20 shown as an example has a convex outer surface 21 which, when the container 1 is moved reciprocating along the axes of movement 4, 5 in a plane which is perpendicular to its longitudinal central axis 6, permits the reciprocating movement in trajectory curves which cause the convex outer surface 21 to move along the concave wall of the container 1.

As an example of a container 1 with an at least triangular cross-section, FIG. 3 shows a container 1 with a pentagonal cross-section. The container 1 contains, at a spacing from the container 1, a grinding body 20 which has the same cross-section as the container 1, but with smaller dimensions, for a spacing from the container 1, over which the grinding body 20 moves within the container 1 during the reciprocating movement of the container 1.

FIG. 4 shows a container 1 with a pentagonal cross-section, in which spherical grinding body 20 are contained.

FIG. 5 shows a container 1 whose wall 7 has openings 8 that are smaller than the grinding bodies 20 it contains. The wall 7 is surrounded at a spacing by an outer wall 9, which covers the openings 8. The wall 7, which forms an inner wall, forms a double wall with the outer wall 9. The inner cross-section of the container 1, which is spanned by the wall 7, is preferably covered at each end by a lid 2. The gap 10, which is formed between the outer wall 9 and the inner wall 7 by the spacing between them, is preferably covered at its terminal cross-sections by a lid 12, which is shown in sections, and/or a line 13 connected to the lid 12.

As an example of a grinding body 20 with an at least triangular cross-section, FIG. 6 shows a grinding body 20 with a star-shaped cross-section with 6 beams. This grinding body is contained at a spacing in a container 1 which has the same cross-sectional shape as the grinding body 20 in larger dimensions. The grinding body 20 with an at least triangular cross-section is hollow and has an inner cavity 22, which is connected to its outer surface 21 by means of a through opening 23. The through opening 23 therefore also connects the space which is formed between the grinding body 20 and the container 1 and in which particles are loaded and comminuted between the grinding body 20 and the container 1.

FIGS. 7A and 7B show, using the example of a star-shaped grinding body 20, a grinding body 20 with an at least triangular cross-section which is continuously offset along its central axis, so that the cross-section is twisted, for example in a spiral around the central axis. As preferred, the inner cross-section of the container 1 at a spacing from the grinding body has the same cross-sectional shape which is continuously offset along the central axis 6 of the container, so that the inner cross-section is twisted in a spiral around the central axis 6. In this embodiment, the movement of the grinding body 20 in the container can generate a conveying effect in the direction of the central axis of the container and of the grinding body and/or press the grinding body 20 against a lid 2 which covers a cross-sectional opening of the container 1.

### REFERENCE NUMBERS

1 container
2, 2A lid
3 passage opening
4, 5 axis
6 longitudinal central axis
7 inner wall
8 opening
9 outer wall
10 gap
12 lid
13 line
2 container wall
20 grinding body
21 outer surface of the grinding body
22 grinding body cavity
23 passage opening
30 sensor
31 electrical cable
32 device for generating electrical voltage
33 transmitter
34 data line
35 electrical cable

1. A device for producing comminuted particles from a solid material, comprising a container and a drive the container to a reciprocating movement along a trajectory curve, the device further comprising at least one grinding body loosely contained in the container, the trajectory curve comprising a sequence of trajectory segments which can be generated by superimposing the reciprocating movement along at least two axes with different frequencies and/or with phase offset and which each comprise exactly one complete reciprocating movement along the axis along which the reciprocating movement takes place with a lower one of the two frequencies and each having at least one apex in which the direction changes by at least 90° within a maximum of 24.5% of the length of a trajectory segment.

2. The device according to claim 1, wherein the trajectory segments have at least one apex at which they change their direction by at least 120° within a maximum of 10% of the length of a trajectory segment.

3. The device according to claim 1, which is set up to change the frequencies and/or the phase offset during the reciprocating movement.

4. The device according to claim 1, wherein the difference in frequencies is at least 0.01 Hz and 0.01% to 900% and/or the phase offset is 0.0028% to 50% of the length of a trajectory segment.

5. The device according to claim 1, wherein the trajectory curve has at least one trajectory segment which comprises a rectilinear section.

6. The device according to claim 1, wherein the trajectory curve lies in the plane of the cross-section of the container.

7. The device according to claim 1, wherein the at least one grinding body is selected to have a lower density than the liquid in which the solid is suspended.

8. The device according to claim 1, wherein the reciprocating movement along the trajectory curve is driven by a transmission which is at least a belt drive and/or a friction gear driven by exactly one motor.

9. The device according to claim 1, wherein the at least one trajectory curve is predetermined and the device is set up to change the frequency of the reciprocating movement in a controlled manner in dependence on the particle size.

10. The device according to claim 1, the device having a sensor which is connected to a controller which is set up to control the frequency of the reciprocating movement and/or the acceleration maximum during the reciprocating movement depending on the signal of the sensor.

11. The device according to claim 1, the device having a device attached to the container, the device having a magnet and a coil arranged movably relative to the magnet, which are set up to generate electrical voltage when moving relative to one another and are connected by means of an electrical line to a transmitter attached to the container.

12. The device according to claim 10, wherein that the sensor is an acoustic sensor which is attached to the container or is fixed at a spacing from an apex of a trajectory segment on a frame on which the container is guided for reciprocating movement.

13. The device according to claim 11, wherein the sensor is attached to the container and is connected to the transmitter for transmitting sensor signals.

14. The device according to claim 1, wherein the container is driven to a reciprocating movement at least along one of the linear axes of movement with a maximum acceleration of at least 0.5 m/s².

15. The device according to claim 1, wherein the container wall is concave with respect to the central axis of the container.

16. The device according to claim 1, wherein the container has an inner cross-section which corresponds to the shape of the cross-section of the at least one grinding body and which surrounds the grinding body with a spacing.

17. The device according to claim 16, wherein the grinding body has an at least triangular cross-section and the trajectory segments each have a number of spacing which is equal to the number of corners of the cross-section of the grinding body and of the inner cross-section of the container.

18. The device according to claim 1, wherein the grinding body has a cross-section which is continuously offset along its central axis and the inner cross-section of the container at a spacing from the grinding body has the same cross-sectional shape which is continuously offset along the central axis of the container.

19. The device according to claim 1, wherein the inner cross-section of the container is twisted spirally about its central axis and the inner cross-section of the container is covered by terminal lids, at least one of which optionally has an opening.

20. The device according to claim 1, wherein the grinding body is hollow and has a through opening connecting its inner cavity to its outer surface, the container having a terminal lid which covers its cross-section and which has an opening arranged in the lid which is arranged matching the inner cavity of the grinding body.

21. The device according to claim 1, wherein the container contains exactly one grinding body.

22. The device according to claim 1, wherein the grinding body has a longitudinal extension which comprises at least 80% of the height of the container perpendicular to the cross-section of the container.

23. The device according to claim 1, wherein the grinding body is convex along its longitudinal extension.

24. The device according to claim 1, wherein the grinding body has a cross-section which has a wide surface which is wider by at least a factor of 1.5 than the thickness of the grinding body perpendicular to the wide surface.

25. The device according to claim 1, wherein the grinding body has a circular, oval or at least hexagonal cross-section, with grooves and/or protruding webs arranged perpendicular to the cross-section of the grinding body.

26. The device according to claim 1, wherein the reciprocating movement to which the container is driven in the first phase is a linear reciprocating movement with a maximum acceleration of at least 50 m/s² and in the subsequent second phase the reciprocating movement in trajectory segments comprise no apices.

27. The device according to claim 1, wherein the wall of the container has openings and this wall is enclosed at a distance from an outer wall.

28. (canceled)
